(19) United States
(12) Patent Application Publication
(10) Pub. No.: US 2013/0238647 A1
(43) Pub. Date: Sep. 12, 2013

(54) Diagnostic System and Method

(71) Applicant: Andrew Thompson, Portola Valley, CA (US)

(72) Inventor: Andrew Thompson, Portola Valley, CA (US)

(73) Assignee: Proteus Digital Health, Inc., Redwood City, CA (US)

(21) Appl. No.: 13/641,864

(22) PCT Filed: Apr. 19, 2011
(86) PCT No.: PCT/US11/33038

§ 371 Date: Dec. 20, 2012

Related U.S. Application Data
(60) Provisional application No. 61/326,648, filed on Apr. 21, 2010.

(51) Int. Cl. G06F 19/00

(52) U.S. Cl. CPC G06F 19/34
USPC 707/758

(57) ABSTRACT

Disclosed are an apparatus and system for providing diagnosis information to a requestor. A request module receives information related to a request from the requestor for diagnosis and to facilitate communication to at least one expert resource. A receive module receives at least one response to the request for diagnoses from the at least one expert resource. A select module in communication with the receive module analyzes the at least one response and, based on the analysis, communicates information to at least one predetermined destination. A method is disclosed where a request module receives a request, a receive module receives a plurality of responses to the request and from the plurality of responses, a select module selects a subset of responses and communicates the subset of responses to a predetermined destination.

### CROSS-REFERENCE TO RELATED APPLICATION

This application claims the benefit of U.S. Provisional Patent Application Ser. No. 61/326,648, filed Apr. 21, 2010 and entitled “Diagnostic System and Method,” the disclosure of which is hereby incorporated by reference in its entirety.

### INTRODUCTION

Conventional methods for diagnosing routine health problems may be imperfect and inaccurate. To illustrate, a child awaking with a mild rash and a cough may have to be taken to the pediatrician's office, examined, and diagnosed to ascertain the underlying cause and the prescribed treatment for the health event. This process often results in delays in diagnosis, e.g., waiting for an appointment with the healthcare provider, traveling to the provider's offices, etc. This process may also result in incurred costs, e.g., cost for healthcare, as well as logistical expenditures, e.g., time consumed rearranging parents' schedules to transport the child to the health care provider, etc.

Conversely, relying on persons other than health providers, e.g., acquaintances or friends, for diagnostic advice may produce inaccurate, and therefore, less reliable, diagnostic and treatment theories. Thus, there remains an unmet need for a reliable technique and tool that can accurately diagnose and treat routine problems.

### SUMMARY

In one aspect, a system provides diagnosis information to a requestor. A request module receives information related to a request from the requestor for diagnosis and facilitates communication to at least one expert resource. A receive module receives at least one response to the request for diagnoses from the at least one expert resource. A select module in communication with the receive module analyzes the at least one response and, based on the analysis, communicates information to at least one predetermined destination.

### BRIEF DESCRIPTION OF THE DRAWINGS

FIG. 1 illustrates a diagnostic environment having a diagnostic system, according to one aspect of the present invention.

FIG. 2 illustrates a request module of the diagnostic system of FIG. 1, according to one aspect of the present invention.

FIG. 3 illustrates an expert system of the diagnostic system of FIG. 1, according to one aspect of the present invention.

FIG. 4 illustrates a select module of the diagnostic system of FIG. 1, according to one aspect of the present invention.

FIG. 5 illustrates a flowchart of a diagnostic method, according to one aspect of the present invention.

FIG. 6 illustrates one aspect of a computing device which can be used in one aspect of a system to implement the various described aspects of the diagnostic system of FIG. 1, according to one aspect of the present invention.

### DESCRIPTION

A diagnostic apparatus, system, and method are provided. For example, wide area networks such as the Internet may be used as a conduit and a resource of diagnostic data to extract diagnostic data, normalize the data, e.g., in an expert system, and package it, e.g., using automatic intelligence and other tools associated with components of various aspects of the present invention for use by a variety of users.

In various aspects, the diagnostic system comprises a request module, a receive module, a select module and, optionally, an expert system. In various other aspects, the method comprises steps of initiating a request; receiving a plurality of responses to the request; e.g., using automatic intelligence and other tools associated with components of various aspects of the present invention selecting a set of responses; and, optionally, updating a knowledge base with the selected set of responses. Various venues and resources may apply.

Aspects of the present invention may be useful in a variety of applications, including diagnosis of a health event or other issue.

### Diagnostic System

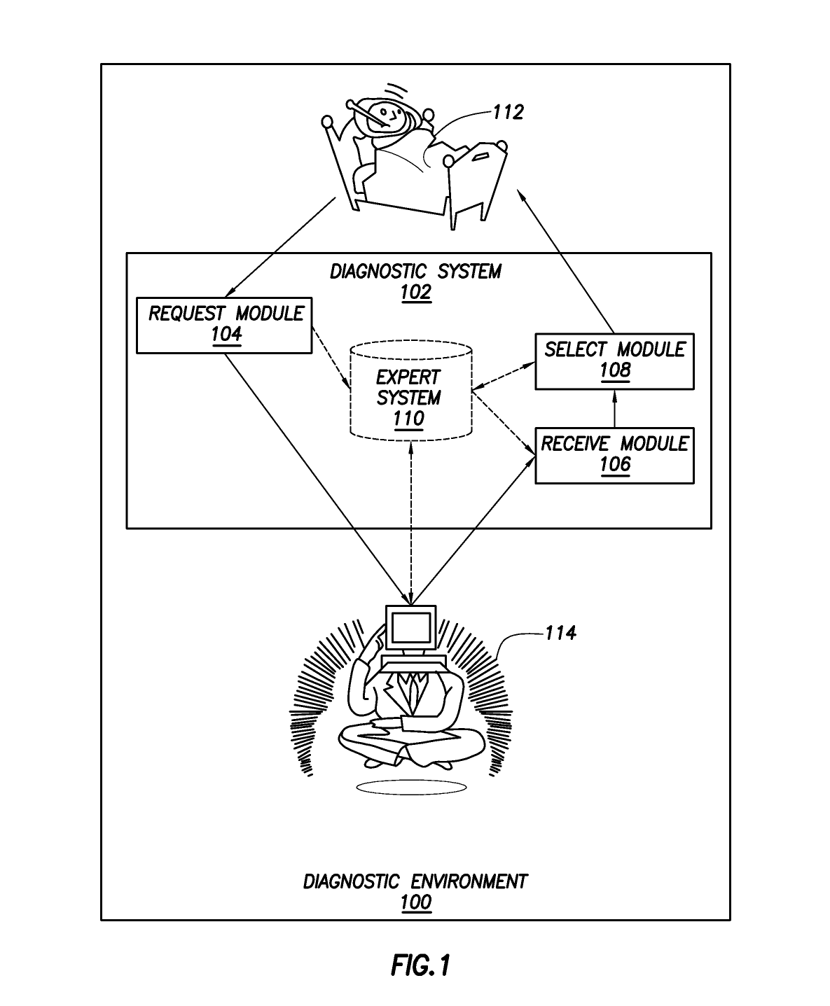

FIG. 1 is a block diagram of a diagnostic environment 100 including a diagnostic system 102, according to one aspect of the present invention. In various aspects, diagnostic system 102 includes a request module 104, a receive module 106, a select module 108, and, optionally, an expert system 110. Diagnostic system 102, for example, may facilitate diagnoses according to various methods and for a variety of issues. In one aspect, receive module 106 and select module 108 may be implemented as a single unit.

To illustrate, a requestor 112, such as parents of a child exhibiting various medical symptoms, may send a request via request module 104 to a set of expert resources 114. Expert resources 114 may include, for example, expert system 110. Expert resources 114 may provide, via a variety of communication options, diagnostic information (sometimes referred to herein as “responses”). The diagnostic information may be received by receive module 106. Receive module 106 may provide the diagnostic information to select module 108. Select module 108, may provide the responses, or a subset of the responses, to requestor 112. In various aspects, select module 108 may analyze and compare responses to determine a subset of responses deemed to be the most accurate diagnoses of the health event.

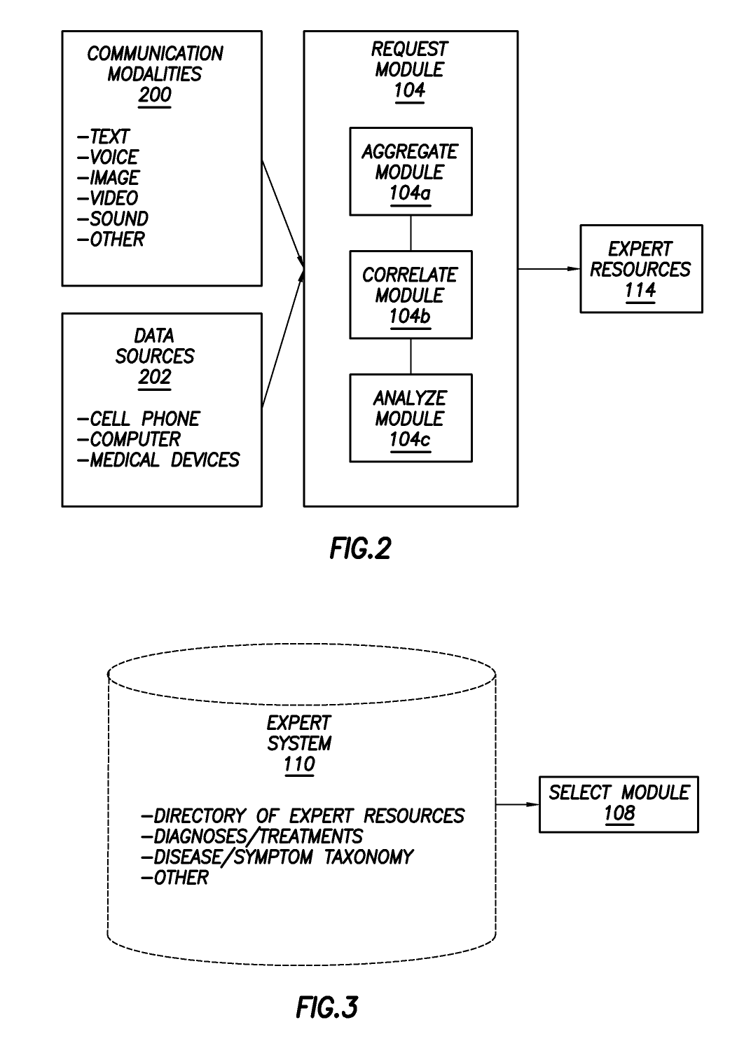

FIG. 2 illustrates one aspect of request module 104 of the diagnostic system 102 of FIG. 1, according to one aspect of the present invention. With reference now to FIGS. 1 and 2, in various aspects, request module 104 may include, for example, any one or more modules such as, for example, aggregate module 104a, correlate module 104b, and analyze module 104c. Request module 104 may function to receive a request from requestor 112 or requestor's device and facilitate communication to receive module 106, e.g., either directly or via one or more expert resources 114, such as expert system 110. Various data techniques and methods may be employed in various aspects to enable or effect particular process, goals, and/or deliverables. Such techniques and methods include, for example, data fusion of various data types and streams, object tagging, automatic intelligence, etc. One skilled in the art will recognize that request module 104 may be configured and implemented in various ways, e.g., integrated into a single device such as a computer or across multiple devices; integrated as software, hardware, or combinations thereof, etc.

In some aspects, request module 104 may include an aggregate module 104a. Aggregate module 104a may facilitate aggregation of various sources, types, and/or modalities of information. Various communication modalities 200 may be employed to communicate with request module 104. To continue with the foregoing illustration, for example, parents may use a cell phone to capture various data related to a request for diagnoses. Cell phone modalities 200 that may be employed include, for example, text, voice, images, video, sound, and other such modalities. To illustrate, the parents may use the cell phone to capture an image of the child's rash, provide a textual explanation of the child's symptom and history, such as recent exposure to poison oak; capture an audio recording of the child's cough and provide all of the aforementioned data to request module 104.

In various aspects, request module 104 may include correlate module 104b to combine, analyze, correlate, etc., various data according to a predetermined scheme to facilitate diagnosis. To continue with the foregoing illustration, data of the image, text, and audio files related to the child and provided to request module 104 may be correlated into a synopsis or other format that readily facilitates diagnosis by the expert source(s). Various techniques may be employed, including object tagging, etc.

In certain aspects, parallel data streams may be provided to request module 104 from a variety of data sources 202 besides a single device, e.g., a cell phone. In addition to cell phones, such data sources 202 may include, for example, computers, medical devices, and the like. Medical devices may include, for example, cardiac and other lead devices, ingestible devices and systems, including sources described in U.S. patent application Ser. No. 12/564,017 entitled, “Communication System with Partial Power Source,” filed Sep. 21, 2009 and published as 2010-0081894 A1 dated Apr. 1, 2010 and U.S. patent application Ser. No. 12/522,249 entitled, “Ingestible Event Marker Data Framework,” filed Jul. 2, 2009 and published as 2011-0009715 A1 dated Jan. 13, 2011, where the disclosure of each of the foregoing is incorporated herein by reference in its entirety. To illustrate, a medical device such as a detector or receiver of a communication system with a partial power source may be physically associated with the child and directly or indirectly provide event marker data and/or other data to request module 104 in addition to the information provided by the parents via the cell phone. In another aspect, a receiver communicatively coupled to a person may send information associated with the physiology of the person to an external device as described in U.S. patent application Ser. No. 12/673,326 entitled, “Body-Associated Receiver and Method,” filed Dec. 15, 2009 and published as 2010-0312188 A1 Dec. 9, 2010. Such data may be aggregated and correlated via aggregate module 104a and correlate module 104b, respectively.

Thus, one output of correlate module 104b may be a compendium of request information provided in various formats and via various communication paths using, for example, data fusion to combine data from the multiple sources and to gather such information in order to achieve inferences, which may be more efficient and potentially more accurate than if they were achieved by means of a single source.

In various aspects, request module 104 may include analyze module 104c to analyze various data according to a predetermined scheme to facilitate communication to a particular set of expert resources 114. To continue with the foregoing illustration, analyze module 104c analyzes the child's compendium and determines that the rash symptom is significant. Analyze module 104c may further determine a subgroup of expert resources having particular expertise in diagnosis and/or treatment of rashes to which the request will be sent.

Expert resources 114 may include any group, source, repository, etc. in any format or configuration that functions to provide diagnostic information in response to the request, sometimes referred to herein as a “response.” In various aspects, expert resources 114 may be provided, via one or more institutions, such as select universities and businesses; via a repository of information such as expert system 110, described hereinafter, and via other such expert resources. Expert resources 114 may be accessed using a variety of methods. One such method is crowdsourcing, i.e., outsourcing the diagnostic task to a large group of people or community through an open call. To illustrate, request module 104 communicates (via various modes) the parents' request for diagnoses to devices of a preselected group of experts such as university faculty of several universities known for diagnostic expertise in a particular field and/or expert providers in hospitals. Each expert reviews the request and responds with a diagnosis or, in some cases, a quote or other bargained for exchange for delivery of a diagnosis to the parents. (Various business and payment models may be applied.)

One such expert resource 114; namely, expert system 110 may be employed as both a source of diagnostic information and a part of diagnostic system 102. As a source of diagnostic information, request module 104 may be communicating to expert system 110, e.g., a computer system having a data repository, which may analyze the request, search the repository for the appropriate diagnosis, and communicate the diagnoses to select module 108.

As a part of diagnostic system 102, expert system 110 may intelligently self-update, e.g., add the request information and diagnostic response information to itself (expert system 110), such that the added information enhances the content of expert system 110 and is available to facilitate response(s) to future requests. In various aspects, expert system 110 may include a directory of expert sources for onward communication of the request, various diagnoses, various treatments, disease and symptom taxonomies, etc.

Expert system 110 may communicate responses to receive module 106 which, in turn, communicates responses to select module 108.

Select module 108 receives the response(s) from either receive module 106 or expert resource(s) 114, such as expert system 110, and performs at least one of the following actions: communicates the response to requestor 112 and analyzes the response and, from the analysis, determines an appropriate subset of responses for onward communication to requestor 112.

FIG. 3 illustrates one aspect of an expert system 110 of diagnostic system 102 of FIG. 1, according to one aspect of the present invention. As shown in FIG. 3, expert system 110 may include a directory of expert resources, a listing of diagnoses and treatments, and a disease and symptom taxonomy, among other, expert system 110 resources. Expert system 110 is in communication with select module 108.

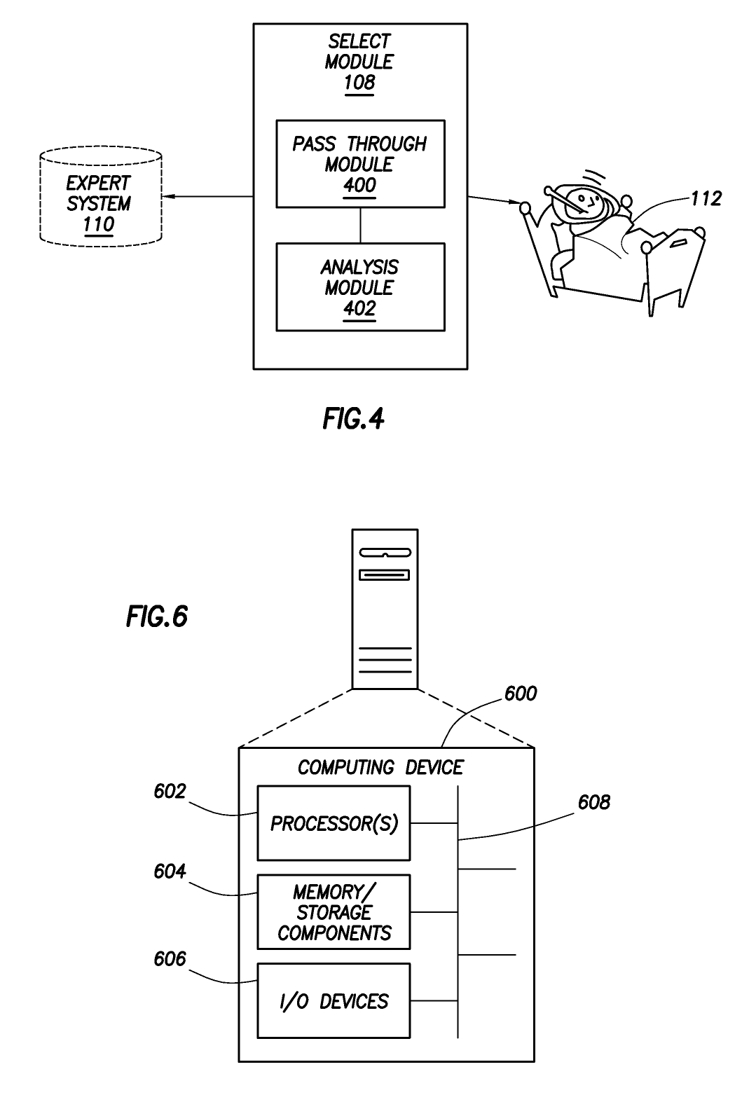

As shown in FIG. 4, in various aspects, select module 108 comprises a pass through module 400 and an analysis module 402. In one aspect, pass through module 400 communicates responses directly to requestor 112 without determination of an appropriate subset of responses. Thus, in various aspects, select module 108 may be one and the same as receive module 106, e.g., in terms of functionality, configuration, etc.

Analysis module 402 performs analysis of responses according to a predetermined scheme, e.g., a software program or other, which may (based on predetermined criteria such as least costly response, response most likely to be an accurate diagnosis, response from expert resources of highest regard, etc.) narrow the selection of responses to a selected subgroup of responses. To continue with the foregoing illustration, upon receipt of a variety of rash diagnoses from five universities of interest and three hospital experts, select module 108 analyzes which universities and hospital experts are ranked highest in that degree of expertise and which diagnosis is most likely the cause of the child's rash and, as a result of the analysis, selects two responses of the five for onward communication to a device associated with the parents. Source information needed to complete such an analysis may also be derived from a variety of sources, e.g., select module 108 may probe expert system 110 and/or other sources for information pertinent to accuracy of rash diagnoses and ranking of universities and hospital experts.

In various aspects, select module 108 may also contribute to expert system 110 by communicating the subset of responses to expert system 110. In turn, expert system 110 may plow the subset of responses across various information areas of expert system 110 to enhance its intelligence and responsiveness to requests. To illustrate, based on the two selected responses, expert system 110 may upgrade the rankings of the two universities associated with the selected responses.

In yet other aspects, expert resources 114 may use expert system 110 in formulating their responses, e.g., university resources may use expert system 110 to extract information pertinent to a request and, from an analysis of the information, provide a response to receive module 106.

Turning now to FIG. 5, where a flowchart of a diagnostic method 500, according to one aspect of the present invention, is illustrated. With reference now to FIGS. 1 and 5, a diagnostic method 500 includes, at 502, receiving a request by request module 104. At 504, receiving a plurality of responses to the request by receive module 106. At 506, the method 500 further includes selecting a subset of responses, from the plurality of responses, by select module 108. At 508, communicating the subset of responses to a predetermined destination by select module 108. Optionally, in various aspects, the diagnostic method 500 further includes, at 510, at least one of updating an expert 100 system with information related to the request and, at 512, updating an expert system 100 with information related to the subset of responses by any one of request module 104, select module 108, and/or expert resources 114.

One skilled in the art will recognize that diagnostic system and method may be configured and implemented using a variety of devices, including various combinations of hardware and software. Further, various modules may be integrated into a single device, spread between various devices, communication modalities, and/or schemes, or implemented in any way conducive to providing the functionality described here using technologies now known or developed in the future. Further, diagnostic system and method communicably interoperates with components and devices via a variety of communication modes and vehicles, e.g., networks such as cellular networks and the Internet. Examples of system components include handheld devices such a cell phones, etc., servers, personal computers, desktop computers, laptop computers, intelligent devices/appliances, etc., as heretofore discussed.

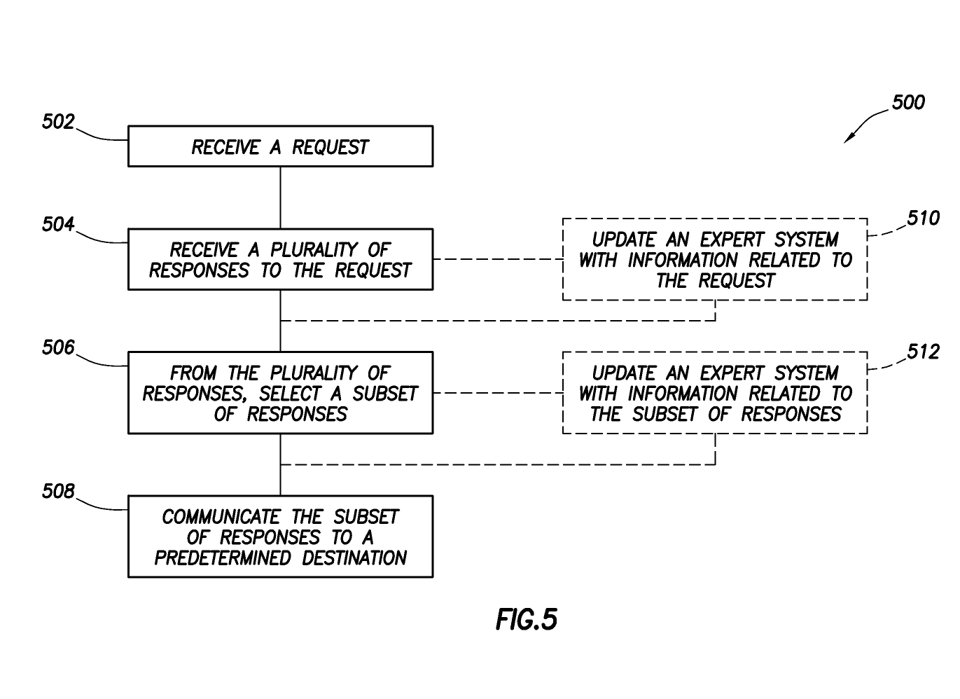

FIG. 6 illustrates one aspect embodiment of a computing device 600 which can be used in one aspect of a system to implement the various described aspects of the diagnostic system of FIG. 1, according to one aspect of the present invention. The computing device 600 may be employed to implement one or more of the computing devices discussed hereinabove. For the sake of clarity, the computing device 600 is illustrated and described here in the context of a single computing device. It is to be appreciated and understood, however, that any number of suitably configured computing devices can be used to implement any of the described embodiments. For example, in at least some implementations, multiple communicatively linked computing devices are used. One or more of these devices can be communicatively linked in any suitable way such as via one or more networks. One or more networks can include, without limitation: the Internet, one or more local area networks (LANs), one or more wide area networks (WANs) or any combination thereof.

In this example, the computing device 600 comprises one or more processor circuits or processing units 602, one or more memory circuits and/or storage circuit component(s) 604 and one or more input/output (I/O) circuit devices 606. Additionally, the computing device 600 comprises a bus 608 that allows the various circuit components and devices to communicate with one another. The bus 608 represents one or more of any of several types of bus structures, including a memory bus or memory controller, a peripheral bus, an accelerated graphics port, and a processor or local bus using any of a variety of bus architectures. The bus 608 may comprise wired and/or wireless buses.

The processing unit 602 may be responsible for executing various software programs such as system programs, applications programs, and/or modules to provide computing and processing operations for the computing device 600. The processing unit 602 may be responsible for performing various voice and data communications operations for the computing device 600 such as transmitting and receiving voice and data information over one or more wired or wireless communications channels. Although the processing unit 602 of the computing device 600 includes single processor architecture as shown, it may be appreciated that the computing device 600 may use any suitable processor architecture and/or any suitable number of processors in accordance with the described embodiments. In one embodiment, the processing unit 602 may be implemented using a single integrated processor.

The processing unit 602 may be implemented as a host central processing unit (CPU) using any suitable processor circuit or logic device (circuit), such as a as a general purpose processor. The processing unit 602 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 602 may be coupled to the memory and/or storage component(s) 604 through the bus 608. The memory bus 608 may comprise any suitable interface and/or bus architecture for allowing the processing unit 602 to access the memory and/or storage component(s) 604. Although the memory and/or storage component(s) 604 may be shown as being separate from the processing unit 602 for purposes of illustration, it is worthy to note that in various embodiments some portion or the entire memory and/or storage component(s) 604 may be included on the same integrated circuit as the processing unit 602. Alternatively, some portion or the entire memory and/or storage component(s) 604 may be disposed on an integrated circuit or other medium (e.g., hard disk drive) external to the integrated circuit of the processing unit 602. In various embodiments, the computing device 600 may comprise an expansion slot to support a multimedia and/or memory card, for example.

The memory and/or storage component(s) 604 represent one or more computer-readable media. The memory and/or storage component(s) 604 may be implemented using any computer-readable media capable of storing data such as volatile or non-volatile memory, removable or non-removable memory, erasable or non-erasable memory, writeable or re-writeable memory, and so forth. The memory and/or storage component(s) 604 may comprise volatile media (e.g., random access memory (RAM)) and/or nonvolatile media (e.g., read only memory (ROM), Flash memory, optical disks, magnetic disks and the like). The memory and/or storage component(s) 604 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 606 allow a user to enter commands and information to the computing device 600, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 600 may comprise an alphanumeric keypad coupled to the processing unit 602. The keypad may comprise, for example, a QWERTY key layout and an integrated number dial pad. The computing device 600 may comprise a display coupled to the processing unit 602. The display may comprise any suitable visual interface for displaying content to a user of the computing device 600. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 602 may be arranged to provide processing or computing resources to the computing device 600. For example, the processing unit 602 may be responsible for executing various software programs including system programs such as operating system (OS) and application programs. System programs generally may assist in the running of the computing device 600 and may be directly responsible for controlling, integrating, and managing the individual hardware components of the computer system. The OS may be implemented, for example, as an OS known under any one of the following trade designations: “MICROSOFT WINDOWS,” “SYMBIAN OSTM,” “EMBEDIX,” “LINUX,” “BINARY RUN-TIME ENVIRONMENT FOR WIRELESS (BREW),” “JAVA,” “ANDROID,” “APPLE” or other suitable OS in accordance with the described embodiments. The computing device 600 may comprise other system programs such as device drivers, programming tools, utility programs, software libraries, application programming interfaces (APIs), and so forth.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is to be understood that various aspects of this invention is not limited to particular embodiments described herein, and as such may vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A system for providing diagnosis information to a requestor, comprising:
a request module to receive information related to a request from the requestor for diagnosis and to facilitate communication to at least one expert resource;
a receive module to receive at least one response to the request for diagnoses from the at least one expert resource; and
a select module in communication with the receive module to analyze the at least one response and, based on the analysis, communicate information to at least one predetermined destination.

2. The system of claim 1, further comprising an expert system to receive the request from the request module and generate the at least one response to the request.

3. The system of claim 2, wherein the expert system comprises at least one of a directory of expert resources, a listing of diagnoses and treatments, and a disease and symptom taxonomy.

4. The system of claim 1, wherein the receive module and the select module are implemented as a single unit.

5. The system of claim 1, wherein the request module comprises at least one of:
an aggregate module to aggregate data associated with the request;
a correlate module to correlate data associated with the request; and
an analyze module to analyze data associated with the request.

6. The system of claim 1, wherein the select module comprises at least one of:
a pass through module; and
an analysis module.

7. A method, comprising:
receiving a request by a request module;
receiving a plurality of responses to the request by a receive module;
from the plurality of responses, selecting a subset of responses by a select module; and
communicating the subset of responses to a predetermined destination by the select module.

8. The method of claim 7, further comprising:
updating an expert system with information related to the request by the request module.

9. The method of claim 7, further comprising:
updating an expert system with information related to the subset of responses by the select module.

10. An apparatus, comprising:
a request module to receive information related to a request from a requestor for diagnosis and to facilitate communication to at least one expert resource;
wherein the request module is configured to receive the information in a plurality of communication modalities from a plurality of data sources; and
wherein the request module is configured to send the request to the at least one expert resource.

11. The apparatus of claim 10, wherein the request module is configured to transmit the request to at least one expert system.

12. The apparatus of claim 10, wherein the request module further comprises:
an aggregate module to aggregate data associated with the request;
a correlate module to correlate data associated with the request; and
an analyze module to analyze data associated with the request.

13. An apparatus, comprising:
a receive module in communication with a select module, the receive module to receive at least one response to a request for diagnoses from at least one expert resource and to provide diagnostic information to the select module.

14. The apparatus of claim 13, wherein the receive module is configured to receive the at least one response to the request generated by the at least one expert system.

15. The apparatus of claim 13, wherein the receive module is configured to receive the at least one response to the request from at least one of a directory of expert resources, a listing of diagnoses and treatments, and a disease and symptom taxonomy of the at least one expert system.

16. An apparatus, comprising:
a select module in communication with a receive module, the select module to analyze at least one response received by the receive module and, based on the analysis, communicate information to at least one predetermined destination.

17. The apparatus of claim 16, further comprising:
a pass through module; and
an analysis module in communication with the pass through module.

18. The apparatus of claim 17, wherein the pass through module communicates the at least one response directly to a requestor without determination of an appropriate subset of responses.

19. The apparatus of claim 17, wherein the analysis module performs analysis of the at least one response according to a predetermined scheme to narrow the selection of the at least one response to a selected subgroup of responses.

20. The apparatus of claim 16, wherein the select module comprises a receive module, the receive module to receive the at least one response to a request for diagnoses from at least one expert resource and to provide diagnostic information to the select module.
